(19) United States
(12) Patent Application Publication
(10) Pub. No.: US 2025/0242856 A1
(43) Pub. Date: Jul. 31, 2025

(54) STEER-BY-WIRE STEERING SYSTEM AND MOTOR VEHICLE

(71) Applicants: thyssenkrupp Presta AG, Eschen (LI); thyssenkrupp AG, Essen (DE)

(72) Inventors: Tamás FEJES, Mezokoevesd (HU); Imre SZEPESSY, Mauren (LI); Ferenc JUNGER, Troy, MI (US)

(73) Assignees: thyssenkrupp Presta AG, Eschen (LI); thyssenkrupp AG, Essen (DE)

(21) Appl. No.: 19/036,947

(22) Filed: Jan. 24, 2025

(30) Foreign Application Priority Data
Jan. 25, 2024 (BE) BE 2024/5043

(51) Int. Cl. B62D 5/04

(52) U.S. Cl. CPC B62D 5/04

(57) ABSTRACT

A steer-by-wire steering system for a motor vehicle comprises a steering wheel having a steering shaft, a feedback actuator, and a measuring device for measuring a steering wheel angle, wherein the feedback actuator has a motor having a motor shaft, which is torque-transmittingly connected to the steering shaft, and a printed circuit board, which is fastened to the motor and has a rotor position sensor for measuring a rotor position of the motor, wherein the measuring device has a first steering wheel angle sensor, which is designed to measure a first rotation angle α of the steering shaft at a shaft end of the steering shaft, wherein the first steering wheel angle sensor is arranged on the printed circuit board, so that it is situated opposite the shaft end.

### CROSS REFERENCE TO RELATED APPLICATION

This application is a U.S. Non-Provisional that claims priority to Belgian Patent Application No. BE 2024/5043, filed Jan. 25, 2024, the entire content of which is incorporated herein by reference.

### FIELD

The present disclosure relates to a steer-by-wire steering system for a motor vehicle and to a motor vehicle.

### BACKGROUND

Steer-by-wire steering systems for motor vehicles receive manual steering commands from the driver by way of rotation of a steering wheel. The steering wheel turns a steering shaft, which is not mechanically, but rather electrically, coupled to the wheels of the motor vehicle that are to be steered. The wheels to be steered are controlled by steering signals. In the process, the steering command or the steering wheel angle is transmitted in the form of a corresponding electrical control signal to a steering actuator which sets the steering lock of the wheels. In order to generate a realistic steering sensation in spite of the lack of a mechanical connection between the steering wheel and the steered wheels, a steer-by-wire steering system may have a feedback actuator, which generates an appropriate feedback torque during steering.

Correct functioning of such a steer-by-wire steering system requires measurement of the current steering wheel angle. Conventional approaches to measuring the steering wheel angle typically require complicated sensors which measure the steering wheel angle at the periphery of the steering shaft and transmit the results to a corresponding controller by cable. The design of such steer-by-wire steering systems is complicated and the susceptibility to errors in the measurement of the steering wheel angle increases.

Thus a need exists for specifying a steer-by-wire steering system which has a simplified structure and a reduced susceptibility to errors in the measurement of the steering wheel angle, as well as specifying a motor vehicle having a steer-by-wire steering system of this kind.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a schematic view of a steer-by-wire steering system according to an exemplary embodiment according to the invention.

FIG. 2 shows a schematic view of a steering wheel having a steering shaft, of a feedback actuator and of a measuring device of the steer-by-wire steering system from FIG. 1.

FIG. 3 shows a view of a detail of the steering shaft and of a first steering wheel angle sensor of the steer-by-wire steering system from FIG. 1.

FIG. 4 shows the relationship between the amplitude A of the rotation angle error Δα and the rotation angle α in the steer-by-wire steering system from FIG. 1 in the form of a line graph.

FIG. 5 shows the relationship between the amplitude A of the rotation angle error Δα and the order of the harmonics in the steer-by-wire steering system from FIG. 1 in the form of a bar graph.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

Specifically, some embodiments include a steer-by-wire steering system for a motor vehicle. The steer-by-wire steering system comprises a steering wheel having a steering shaft, comprises a feedback actuator and comprises a measuring device for measuring a steering wheel angle, wherein the feedback actuator has a motor having a motor shaft, which is torque-transmittingly connected to the steering shaft, and a printed circuit board, which is fastened to the motor and has a rotor position sensor for measuring a rotor position of the motor, wherein the measuring device has a first steering wheel angle sensor, which is designed to measure a first rotation angle α of the steering shaft at a shaft end of the steering shaft, wherein the first steering wheel angle sensor is arranged on the printed circuit board, so that it is situated opposite the shaft end.

The proposed steer-by-wire steering system is therefore based on the idea of using a first steering wheel angle sensor to measure the steering wheel angle, the first steering wheel angle sensor being designed to measure the rotation angle of the steering shaft, i.e. the steering wheel angle, at the shaft end of the steering shaft. For this purpose, the first steering wheel angle sensor is arranged in the region of the shaft end in such a way that it, as an axial extension of the steering shaft, is situated opposite the shaft end, in particular an axial end face of the shaft end. As a result, complicated measuring devices on the periphery of the steering shaft can be dispensed with. This simplifies the design of the steer-by-wire steering system and thus reduces the susceptibility to errors in the measurement of the steering wheel angle. In addition, the installation space required for the steering shaft in the circumferential direction is reduced.

The proposed steer-by-wire steering system is based on the further idea of arranging the first steering wheel angle sensor on the printed circuit board of the feedback actuator, in particular on the printed circuit board of a controller of the feedback actuator, the rotor position sensor of the feedback actuator being arranged on the printed circuit board. As a result, cable connections, which are susceptible to faults, of the sensors to the printed circuit board or the use of a complicated rigid-flex printed circuit board, that is to say a combination of a rigid and a flexible printed circuit board, can be dispensed with, as a result of which the design is further simplified and the susceptibility to errors is further reduced.

In some embodiments, the steering wheel and the steering shaft are coupled to each other in such a way that one revolution of the steering wheel corresponds exactly to one revolution of the steering shaft. The rotation angle of the steering wheel, that is to say the steering wheel angle, therefore always corresponds to the rotation angle of the steering shaft.

The first steering wheel angle sensor can also be referred to as the end-of-shaft sensor.

In a preferred embodiment, the steer-by-wire steering system has a computer unit, which is communicatively connected to the measuring device and is designed to compensate for a rotation angle error Δα of the first steering wheel angle sensor. Such post-processing of the measurement data, in particular during operation, can be used to reduce or compensate for rotation angle errors Δα, in particular measurement errors, in the first steering wheel angle sensor which may occur, in particular, owing to a misalignment of the first steering wheel angle sensor with respect to the steering shaft. The reduction in the measurement errors increases the reliability of measurement of the first steering wheel angle sensor.

It has been found that the rotation angle error Δα generally forms an oscillation, with the second harmonic of this oscillation being the most pronounced, that is to say having the highest amplitude A. It is therefore advantageous when the computer unit is designed to compensate for the rotation angle error Δα using

$$α - A \cdot cos ( 2 \cdot α + φ ) ,$$

where the rotation angle error Δα has the amplitude A and a phase shift φ. As a result, the second harmonic of the rotation angle error Δα is compensated for and thus the rotation angle error Δα is reduced, so that the reliability of measurement of the first steering wheel angle sensor is further increased. This also provides particularly simple and computationally efficient compensation of the rotation angle error Δα.

In a further advantageous embodiment, the measuring device has a second steering wheel angle sensor, which is designed to measure a second rotation angle of the steering shaft at a periphery of the steering shaft. The second steering wheel angle sensor forms a redundant sensor, which is designed to measure the steering wheel angle in parallel with the first steering wheel angle sensor. This ensures the measuring device is able to function even when the first or the second steering wheel angle sensor fails. The susceptibility to errors in the measurement of the steering wheel angle sensors is therefore further reduced.

The steer-by-wire steering system preferably has a connecting means, in particular a belt, for torque-transmitting connection between the motor shaft and the steering shaft. The connecting means is advantageously adapted to reduce a relative movement between the motor and the steering shaft. In particular, the connecting means is adapted such that a tensioning movement, in particular a tensioning travel, further in particular a tensioning travel in the transverse direction of the steering shaft, between the motor and the steering shaft, which tensioning movement is required for the connecting means, in particular for tensioning the connecting means, is reduced, in particular minimized. Since the first steering wheel angle sensor, which is fixedly connected to the motor by the printed circuit board, moves together with the motor during tensioning, this may lead to a misalignment of the first steering wheel angle sensor with respect to the steering shaft, in particular to an offset between the first steering wheel angle sensor and the steering shaft in the transverse direction of the steering shaft. Therefore, possible rotation angle errors Δα of the first steering wheel angle sensor, which may occur on account of such a misalignment, are advantageously further reduced by minimizing the tensioning movement. The reliability of the measurement of the first steering wheel angle sensor is therefore further increased.

Furthermore, a motor vehicle having an above-described steer-by-wire steering system is specified within the scope of some embodiments.

With respect to the effect and the advantages of the motor vehicle described herein, reference is made to the statements made in connection with the steer-by-wire steering system. The steer-by-wire steering system is therefore disclosed as part of the motor vehicle and on its own, i.e. independently of the motor vehicle.

Advantageous features and design details will be explained in more detail below on the basis of an exemplary embodiment with reference to the appended schematic figures.

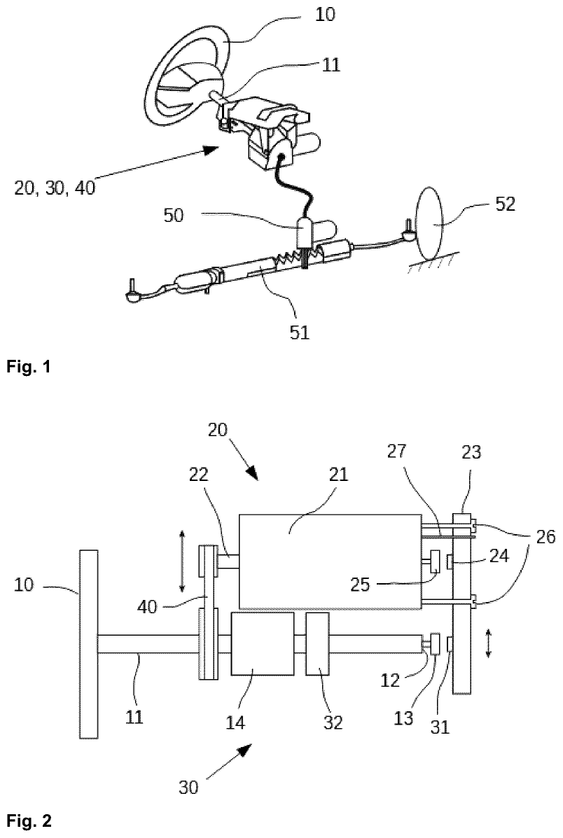

FIG. 1 shows a schematic view of a steer-by-wire steering system of a motor vehicle. The steer-by-wire steering system comprises a steering wheel 10 having a steering shaft 11, comprises a feedback actuator 20, comprises a measuring device 30 for measuring the steering wheel angle and comprises a connecting means 40, which torque-transmittingly connects the steering shaft 11 and the feedback actuator 20. The feedback actuator 20 is communicatively connected to a steering actuator 50, which is adapted to actuate a steering rod 51 in order to effect a steering movement of wheels 52 of the motor vehicle.

FIG. 2 shows a schematic view of the steering wheel 10 having the steering shaft 11, of the feedback actuator 20 and of the measuring device 30 of the steer-by-wire steering system from FIG. 1.

The feedback actuator 20 has a printed circuit board 23. Specifically, the feedback actuator 20 has a controller having the printed circuit board 23. The printed circuit board 23 is arranged on the motor 21. For this purpose, the feedback actuator 20 has two fastening means 26, which fixedly secure the printed circuit board 23 on the motor 21. In addition, it is clear that motor phase wires 27 pass from the motor 21 to the printed circuit board 23.

The printed circuit board 23 has a rotor position sensor 24 for measuring the position of a rotor of the motor 21. The rotor position sensor 24 is designed to detect a target object 25, which is connected to the rotor such that it rotates with the rotor during operation of the steer-by-wire steering system.

The measuring device 30 has a first steering wheel angle sensor 31, which is designed to measure a first rotation angle α of the steering shaft 11 at a shaft end 12 of the steering shaft 11. Specifically, the first steering wheel angle sensor 31 is designed to detect a target object 13, which is attached to the shaft end 12 of the steering shaft 11 and as a result rotates with the steering shaft 11 during operation of the steer-by-wire steering system.

The first steering wheel angle sensor 31 is arranged on the printed circuit board 23. In other words, the first steering wheel angle sensor 31 is thus arranged on the same printed circuit board 23 as the rotor position sensor 24.

The position of the first steering wheel angle sensor 31 on the printed circuit board is selected such that the first steering wheel angle sensor 31 is situated opposite the shaft end 12 of the steering shaft 11. In this case, a gap is formed between the shaft end 12 and the first steering wheel angle sensor 31. Specifically, the first steering wheel angle sensor 31 is situated opposite an axial end face of the shaft end 12, with the target object 13 being arranged in the gap between the axial end face of the shaft end 12 and the steering wheel angle sensor 31 and being fastened to the end face of the shaft end 12.

Here, the first steering wheel angle sensor 31 is arranged substantially coaxially in relation to the steering shaft 11. This also includes an arrangement which differs from an ideally coaxial arrangement only due to a misalignment of the steering wheel angle sensor 31 with respect to the steering shaft 11. The first steering wheel angle sensor 31 may also be arranged non-coaxially in relation to the steering shaft 11.

The steer-by-wire steering system has a computer unit, which is communicatively connected to the measuring device 30. Specifically, the controller of the feedback actuator 20 comprises the computer unit, so that the first steering wheel angle sensor 31 is communicatively connected to the computer unit by the printed circuit board 23.

The computer unit is designed to compensate for a rotation angle error Δα of the first steering wheel angle sensor 31. In other words, the computer unit is designed to correct a deviation in the measured first rotation angle α from the actual rotation angle by post-processing the measurement data. In this case, the measurement data are preferably post-processed during operation of the steer-by-wire steering system, that is to say during travel.

Such post-processing of the measurement data can be used to compensate for rotation angle errors Δα in the first steering wheel angle sensor 31 which may occur owing to a misalignment of the first steering wheel angle sensor 31 with respect to the steering shaft 11. In the embodiment shown, the misalignment corresponds to an offset between the first steering wheel angle sensor 31 and the steering shaft 11 in the transverse direction of the steering shaft 11. The misalignment is indicated by a corresponding arrow in FIG. 2.

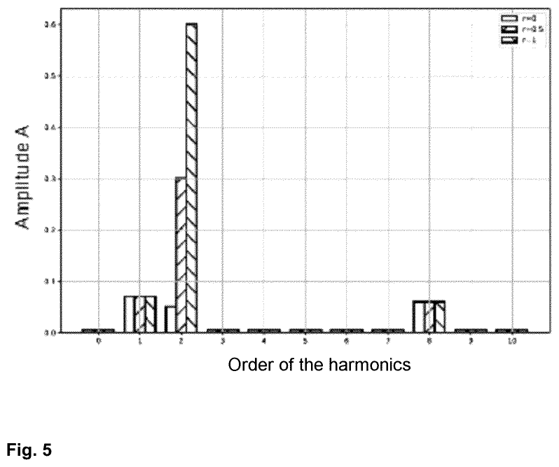

The computer unit is designed to compensate for the rotation angle error Δα using

$$α - A \cdot cos ( 2 \cdot α + φ ) ,$$

where the rotation angle error Δα has the amplitude A and a phase shift φ. As a result, the second harmonic of the rotation angle error Δα, which forms an oscillation, is compensated for, where the second harmonic is the harmonic with the generally highest amplitude A (FIGS. 4 and 5). The compensation reduces, in particular minimizes, the rotation angle error Δα.

The measuring device 30 has a second steering wheel angle sensor 32, which is designed to measure a second rotation angle of the steering shaft 11 at a periphery of the steering shaft 11. For this purpose, the second steering wheel angle sensor 32 is arranged on the steering shaft 11.

Here, the first rotation angle measured by the first steering wheel angle sensor 31 differs from the second rotation angle measured by the second steering wheel angle sensor 32 only by the rotation angle error Δα.

In addition to the first steering wheel angle sensor 31 and/or the second steering wheel angle sensor 32, the measuring device 30 may have further sensors in order to further reduce the susceptibility to errors in the measurement and/or to further increase the reliability of the measurement.

The first steering wheel angle sensor 31 and/or the second steering wheel angle sensor 32 may have a plurality of sensor elements for measuring the rotation angle α. This is a good way of increasing the redundancy.

The steer-by-wire steering system has the connecting means 40 for torque-transmittingly connecting the motor shaft 22 and the steering shaft 11. The connecting means 40 is preferably designed as a belt. The connecting means 40 may be designed differently.

The connecting means 40 is configured to transmit a torque between the motor shaft 22 and the steering shaft 11. A certain degree of tension of the connecting means 40 is required for transmitting torque. In this case, the connecting means 40 is preferably tensioned by way of the motor 21 being moved away from the steering shaft 11 at the end of the production line by a tensioning movement. The distance between the motor 21 and the steering shaft 11 established by this tensioning movement is not predetermined, but rather is defined on the basis of a tension measurement on the production line and can therefore vary from steering system to steering system. Since the first steering wheel angle sensor 31 is fixedly connected to the motor 21 by the printed circuit board 23, this tensioning movement leads to a misalignment of the first steering wheel angle sensor 31 with respect to the steering shaft 11, specifically to an offset between the first steering wheel angle sensor 31 and the steering shaft 11 in the transverse direction of the steering shaft 11 (arrow in FIG. 2).

In order to keep this misalignment as small as possible, the connecting means 40 is adapted to reduce, in particular to minimize, such a tensioning movement between the motor 21 and the steering shaft 11. For example, the geometry, for example the width, the thickness and/or the cross-sectional profile, of the connecting means 40 and also the material from which the connecting means 40 is formed can therefore be configured in such a way that the tensioning movement and thus the offset between the first steering wheel angle sensor 31 and the steering shaft 11 is minimal. Other measures on the connecting means 40 for reducing the tensioning movement are possible.

The steering shaft 11 has a stop 14, which is adapted to limit a steering movement of the steering wheel 10 to a certain angular range.

The sensors of the measuring device 30, in particular the first steering wheel angle sensor 31 and the second steering wheel angle sensor 32, are preferably magnetic and/or inductive sensors. They may also be other sensors, for example potentiometric or optical sensors.

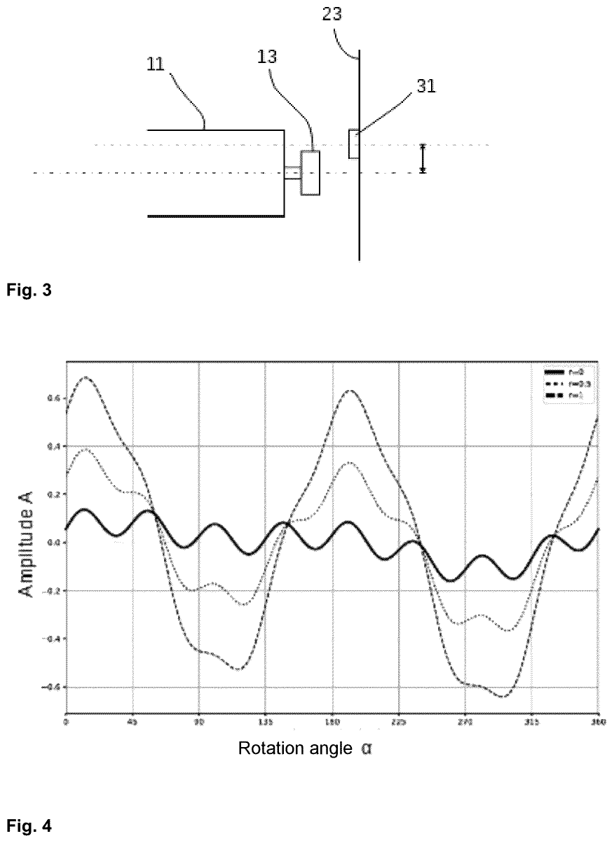

FIG. 3 shows a view of a detail of the steering shaft 11 and of the first steering wheel angle sensor 31 of the steer-by-wire steering system from FIG. 1. In said FIG. 3, the first steering wheel angle sensor 31 is misaligned with respect to the steering shaft 11. Specifically, the first steering wheel angle sensor 31 is depicted offset with respect to the steering shaft 11, specifically the longitudinal axis of the steering shaft 11, in the transverse direction of the steering shaft 11, the cause of this offset being a tensioning movement between the motor 21 and the steering shaft 11.

FIG. 4 shows the relationship between the amplitude of the rotation angle error Δα and the rotation angle α in the steer-by-wire steering system from FIG. 1 in the form of a line graph, with three lines being mapped.

A first, solid line shows the relationship between the amplitude A of the rotation angle error Δα and the rotation angle α with no offset of the first steering wheel angle sensor 31 with respect to the longitudinal axis of the steering shaft 11 in the transverse direction of the steering shaft 11 (r=0). A second, dotted line shows the relationship between the amplitude A of the rotation angle error Δα and the rotation angle α with a medium offset of the first steering wheel angle sensor 31 with respect to the longitudinal axis of the steering shaft 11 in the transverse direction of the steering shaft 11 (r=0.5). A third, dashed line shows the relationship between the amplitude A of the rotation angle error Δα and the rotation angle α with a large offset of the first steering wheel angle sensor 31 with respect to the longitudinal axis of the steering shaft 11 in the transverse direction of the steering shaft 11 (r=1).

It is clear here that the amplitude A of the rotation angle error Δα increases as the offset increases, that is to say as the tensioning movement between the motor 21 and the steering shaft 11 increases.

FIG. 5 shows the relationship between the amplitude A of the rotation angle error Δα and the order of the harmonics in the steer-by-wire steering system from FIG. 1 in the form of a bar chart, where three bars are plotted for each order.

A first, left-hand-side bar shows the amplitude A of the rotation angle error Δα depending on the order of the harmonic with no offset of the first steering wheel angle sensor 31 with respect to the longitudinal axis of the steering shaft 11 in the transverse direction of the steering shaft 11 (r=0). A second, central bar shows the amplitude A of the rotation angle error Δα depending on the order of the harmonic with a medium offset of the first steering wheel angle sensor 31 with respect to the longitudinal axis of the steering shaft 11 in the transverse direction of the steering shaft 11 (r=0.5). A third, right-hand-side bar shows the amplitude A of the rotation angle error Δα depending on the order of the harmonic with a large offset of the first steering wheel angle sensor 31 with respect to the longitudinal axis of the steering shaft 11 in the transverse direction of the steering shaft 11 (r=1).

It is clear here that the amplitude A of the second harmonic of the rotation angle error Δα is the highest.

### LIST OF REFERENCE SIGNS

10 Steering wheel
11 Steering shaft
12 Shaft end
13 Target object
14 Stop
20 Feedback actuator
21 Motor
22 Motor shaft
23 Printed circuit board
24 Rotor position sensor
25 Target object
26 Fastening means
27 Motor phase wires
30 Measuring device
31 First steering wheel angle sensor
32 Second steering wheel angle sensor
40 Connecting means
50 Steering actuator
51 Steering rod
52 Wheel

The invention claimed is:

1. A steer-by-wire steering system for a motor vehicle, comprising:
a steering wheel having a steering shaft;
a feedback actuator; and
a measuring device for measuring a steering wheel angle;
wherein the feedback actuator has a motor having a motor shaft, which is torque-transmittingly connected to the steering shaft, and a printed circuit board, which is arranged on the motor and has a rotor position sensor for measuring a rotor position of the motor;
wherein the measuring device has a first steering wheel angle sensor, which is designed to measure a first rotation angle α of the steering shaft at a shaft end of the steering shaft, wherein the first steering wheel angle sensor is arranged on the printed circuit board, so that it is situated opposite the shaft end.

2. The steer-by-wire steering system according to claim 1, further comprising a computer unit, which is communicatively connected to the measuring device and is designed to compensate for a rotation angle error Δα of the first steering wheel angle sensor.

3. The steer-by-wire steering system according to claim 2, wherein the computer unit is designed to compensate for the rotation angle error Δα using
α−A·cos(2·α+φ),
where the rotation angle error Δα has an amplitude A and a phase shift φ.

4. The steer-by-wire steering system according to claim 1, wherein the measuring device has a second steering wheel angle sensor, which is designed to measure a second rotation angle of the steering shaft at a periphery of the steering shaft.

5. The steer-by-wire steering system according to claim 1, further comprising a connecting means for torque-transmittingly connecting the motor shaft and the steering shaft, which connecting means is adapted to reduce a relative movement between the motor and the steering shaft.

6. The steer-by-wire steering system according to claim 1, further comprising a connecting means for torque-transmittingly connecting the motor shaft and the steering shaft, which connecting means is adapted such that a tensioning movement between the motor and the steering shaft, which tensioning movement is required for the connecting means, is minimized.

7. A motor vehicle having a steer-by-wire steering system according to claim 1.
